(19) United States
(12) Patent Application Publication
(10) Pub. No.: US 2008/0002069 A1
(43) Pub. Date: Jan. 3, 2008

(54) Liquid crystal display device

(75) Inventor: Hirotoshi Abe, Saitama (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/645,689

(22) Filed: Dec. 27, 2006

(30) Foreign Application Priority Data
Jun. 29, 2006 (JP) 2006-180268

(51) Int. Cl. H04N 3/14

(52) U.S. Cl. 348/792; 348/793

(57) ABSTRACT

A liquid crystal display device (1) according to the invention, when an image corresponding to an inputted video signal is a moving image complying with an interlace system, inserts a black signal as an interpolation signal into each of corresponding interlace non-scanning portions (101) without generating the interpolation signal from upper and lower side scanning lines with respect to a scanning line concerned for the video signal (100a or 100b). Alternatively, the interpolation signal generated from the upper and lower side scanning lines with respect to a scanning line concerned for the video signal can also be inserted into each of corresponding interlace non-scanning portions (101) instead of using the black signal.

The present application is based on Japanese patent application No. 2006-180268, the entire contents of which are incorporated herein by reference.

### BACKGROUND

1. Field

One embodiment of the invention relates to a liquid crystal display device, and more particularly to a liquid crystal display device which is capable of executing image processing for inserting a black signal in an IP (Interlace-Progressive) conversion circuit.

2. Description of the Related Art

When a video signal complying with an interlace system is converted into one complying with a progressive system, a video signal is necessary to be interpolated in portions which are not scanned in accordance with interlace scanning. Hereinafter each of the portions is defined as “interlace non-scanning portion”. In particular, an interpolation signal is generated by estimating a motion of the moving image from video signals of a preceding (upper side) scanning line and a subsequent (lower side) scanning line with respect to the interlace non-scanning portion concerned.

In addition, unlike a so-called impulse type display method with which light emission is made only for a moment per one frame of an image in a CRT which has been conventionally used in image display devices, a liquid crystal display device (LCD) which has been recently used in many image display devices adopts a so-called hold type display method with which the light emission is made for the entire time period for each of the frames. For this reason, the LCD has poor responsibility, as its shortcoming, that the displayed image slowly disappears, which results in that a state called “a moving image blur” is easy to occur.

In order to dissolve such “a moving image blur” inherent in the LCD, the various kinds of methods have been devised. The techniques relating to these methods, for example, are disclosed in the Japanese Patent Kokai Nos. 2005-173525 and 2003-143556. One of the various kinds of methods is such that a vertical scanning frequency (60 Hz in Japan etc., and 50 Hz in Europe etc.) is doubled and a black frame is inserted between each two of the existing frames in correspondence to the increased number of frames.

However, in the case of the liquid crystal display devices described in the Japanese Patent Kokai Nos. 2005-173525 and 2003-143556, and the like, respectively, the execution of frequency doubling conversion processing and black frame-inserting processing after completion of the IP conversion results in that corresponding circuit structures are complicated.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing an internal configuration of a liquid crystal display device according to an embodiment of the invention;

FIGS. 2A and 2B are respectively exemplary schematic diagrams showing an operation for black signal-inserting processing executed in the liquid crystal display device according to the embodiment of the invention;

FIG. 3 is an exemplary schematic view showing a display example of an OSD image menu of the liquid crystal display device according to the embodiment of the invention; and

FIGS. 4A and 4B are respectively schematic diagrams showing an interpolation method in an OFF mode phase of the black signal-inserting processing executed in the liquid crystal display device according to the embodiment of the invention.

### DETAILED DESCRIPTION OF PREFERRED EMBODIMENTS

Various embodiments according to the invention will be described hereinafter with reference to the accompanying drawings. In general, according to one embodiment of the invention, there is provided a liquid crystal display device, including: a receiving portion for receiving a video signal; a motion detecting portion for detecting whether an image corresponding to the video signal is a still image or a moving images; and an interpolation signal-inserting portion for, when the motion detecting portion detects that the image corresponding to the video signal is the moving image complying with an interlace system, inserting a black signal into each of interlace non-scanning portions for the video signal.

According to the liquid crystal display device according to the one embodiment of the invention, the execution of the black signal-inserting processing in the IP conversion processing results in that the corresponding circuit structures can be simplified.

In addition, according to a further embodiment of the invention, there is provided a liquid crystal display device, including: a receiving portion for receiving a video signal; a motion detecting portion for detecting whether an image corresponding to the video signal is a still image or a moving images; an interpolation signal-inserting portion for, when the motion detecting portion detects that the image corresponding to the video signal is the moving image complying with an interlace system, inserting a black signal into each of interlace non-scanning portions for the video signal; and a size converting portion for converting a size of the image corresponding to the video signal only when a display size of the image corresponding to the video signal and a display size of a liquid crystal panel for displaying thereon an image are different from each other.

According to the liquid crystal display device according to the one embodiment of the invention, it is possible to prevent the effect of the black signal-inserting processing from being reduced due to the execution of the size conversion processing for the video signal not requiring the size conversion.

In addition, according to still further embodiment of the invention, there is provided a liquid crystal display device, including: a receiving portion for receiving a video signal; a motion detecting portion for detecting whether an image corresponding to the video signal is a still image or a moving images; an interpolation signal-inserting portion for, when the motion detecting portion detects that the image corresponding to the video signal is a moving image complying with an interlace system, inserting a black signal into each of interlace non-scanning portions for the video signal; and a motion detection-evaluating portion for evaluating detection precision in the motion detecting portion by using the block signal inserted as an interpolation signal by the interpolation signal-inserting portion.

According to the liquid crystal display device according to the one embodiment of the invention, the black signal-inserting processing can be utilized in the evaluation for the motion detection precision as well.

According to the invention, the execution of the black signal-inserting processing in the IP conversion processing executed in the liquid crystal display device results in that the corresponding circuit structures can be simplified.

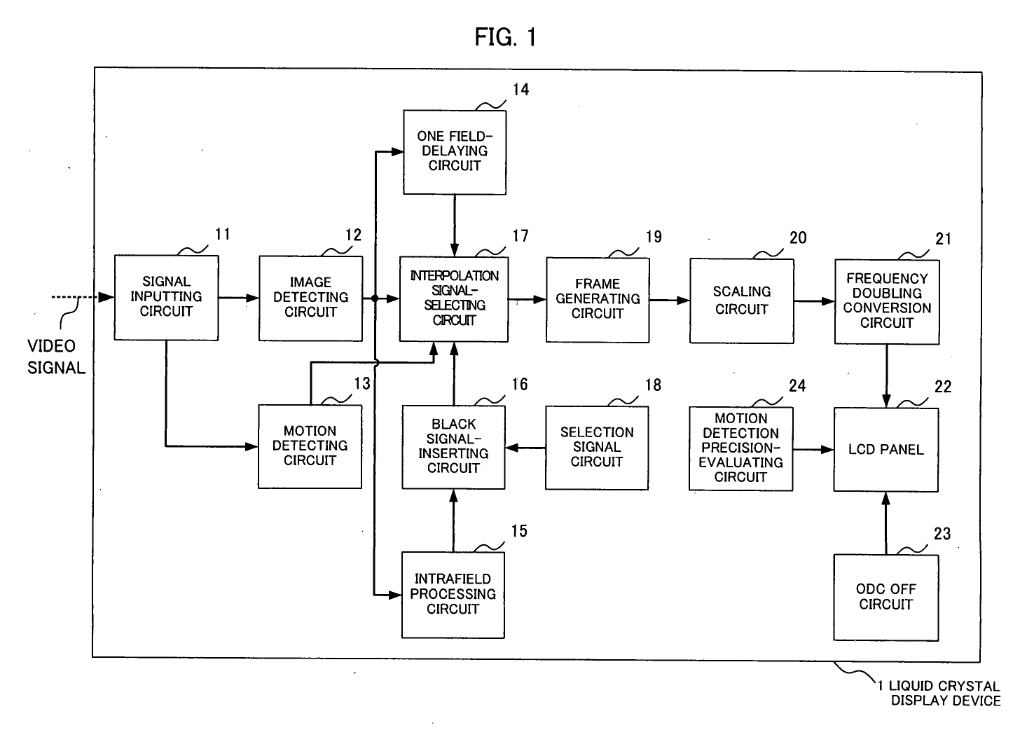

An embodiment of the invention will be described hereinafter with reference to FIG. 1 to FIGS. 4A and 4B.

### [Configuration of Liquid Crystal Display Device]

FIG. 1 is a block diagram showing an internal configuration of a liquid crystal display device according to an embodiment of the invention.

The liquid crystal display device 1 according to the embodiment of the invention includes a signal inputting circuit 11, an image detecting circuit 12, a motion detecting circuit 13, a one field-delaying circuit 14, an intrafield processing circuit 15, a black signal-inserting circuit 16, an interpolation signal-selecting circuit 17, a selection signal circuit 18, a frame generating circuit 19, a scaling circuit 20, a frequency doubling conversion circuit 21, an ODC off circuit 22, an LCD panel 23, and a motion detection precision-evaluating circuit 24.

The signal inputting circuit 11 receives a video signal as its input through reception of a television broadcasting signal via an antenna or the like, transmission of a video signal from an external apparatus connected to the liquid crystal display device 1 via an external terminal or the like, read of a video signal stored in a memory, or the like.

The image detecting circuit 12 detects a size of an image corresponding to the video signal inputted to the signal inputting circuit 11. Note that, the scaling circuit 20 may have the function of the image detecting circuit 12 instead of specially providing the image detecting circuit 12.

The motion detecting circuit 13 detects whether an image corresponding to the video signal which is inputted to the signal inputting circuit 11 and intended to be displayed on the LCD panel 23 is a still image or a moving image. Specifically, the motion detecting circuit 13 compares two continuous frames with each other by obtaining a difference between the two continuous frames, or the like, thereby judging whether the image corresponding to the video signal is the still image or the moving image.

The one field-delaying circuit 14, when the image corresponding to the video signal is judged to be the still image, temporarily stores the video signal of the last field as an interpolation signal for an image for one field.

The intrafield processing circuit 15, when the image corresponding to the video signal is judged to be the moving image, generates an interpolation signal for interpolation for an image for one field.

The black signal-inserting circuit 16 inserts a black signal into each of the interlace non-scanning portions instead of the interpolation signal generated by the intrafield processing circuit 15.

The interpolation signal-selecting circuit 17, when the image corresponding to the video signal is judged to the still image in accordance with the detection result obtained from the motion detecting circuit 13, selects the interpolation signal outputted from the one field-delaying circuit 14, and when the image corresponding to the video signal is judged to be the moving image in accordance therewith, selects the interpolation signal outputted from the black signal-inserting circuit 16.

The selection signal circuit 18 performs the switching relating to whether or not the black signal-inserting circuit 16 should perform the operation for inserting the black signal. The switching concerned is carried out manually or in accordance with selection made by a user. When it is selected that the black signal-inserting circuit 16 should not perform the operation for inserting the black signal, the interpolation signal generated in the intrafield processing circuit 15 is transmitted from the black signal-inserting circuit 16 to the interpolation signal-selecting circuit 17 as it is.

The frame generating circuit 19 interpolates the video signal complying with the interlace system by using the interpolation signal selected in the selection signal-selecting circuit 17 and generates a video signal complying the progressive system.

The scaling circuit 20 changes a size of the image corresponding to the received video signal so that the size of the image concerned is fitted to a size of the LCD panel 23.

The frequency doubling conversion circuit 21 doubles the vertical scanning frequency set for the video signal and also doubles the number of video signal.

The ODC off circuit 22 releases overdrive processing executed in the LCD panel 23.

The LCD panel 23 displays thereon an image corresponding to the video signal transmitted from the frequency doubling conversion circuit 21.

The motion detection precision-evaluating circuit 24 evaluates the precision for the motion detection processing executed in the motion detecting circuit 13.

### [Black Signal-Inserting Processing]

Next, a description will now be given with respect to the black signal-inserting processing executed in the liquid crystal display device 1 according to the embodiment of the invention.

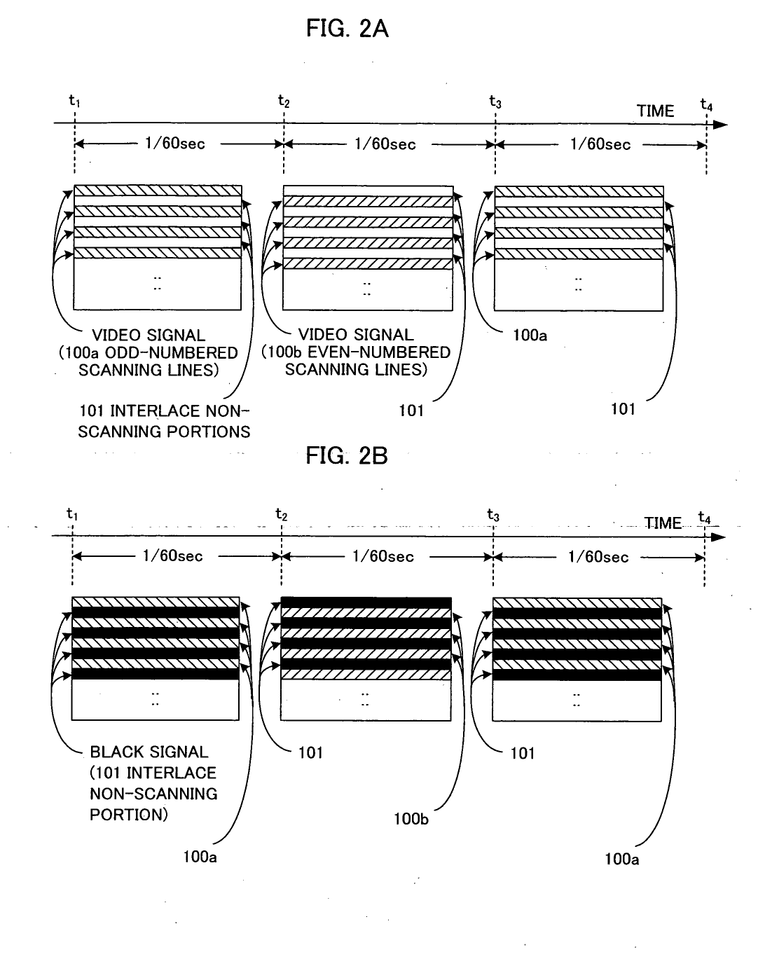

FIGS. 2A and 2B are respectively schematic diagrams showing a situation of the black signal-inserting processing executed in the liquid crystal display device 1.

When receiving the video signal complying with the interlace system, the liquid crystal display device 1 according to the embodiment of the invention, as shown in FIG. 2A, alternately receives a video signal for the odd-numbered scanning lines 100a at t₁ or t₃, and a video signal for the even-numbered scanning lines 10b at t₂ every one field (every 1/60 sec). As shown in FIG. 2B, a black signal is inserted as the interpolation signal to each of the individual interlace non-scanning portions 101. That is to say, for the video signal received at t₁ or t₃, the black signal is inserted into each of the even-numbered scanning lines (101), and for the video signal received at t₂, the black signal is inserted into each of the odd-numbered scanning lines (101).

The black signal is inserted into each of the corresponding interlace non-scanning portions 101 in the phase of the IP conversion, which results in that even when any of the areas on the screen is viewed, the black image is apparently usually inserted into the picture at a rate of 50%. Thus, the so-called “moving image blur” can be prevented from occurring.

Consequently, after the frequency doubling conversion circuit 21 doubles the number of frames, the black signal is inserted as the interpolation signal into each of the corresponding interlace non-scanning portions without inserting any of the black images, which results in that the moving image can be prevented from being blurred.

### [Evaluation for Motion Detection Precision]

The motion detecting circuit 13 executes the motion detection processing for the purpose of judging whether the image corresponding to the video signal is the moving image or the still image. At this time, in order to check whether or not the motion detecting processing normally functions, the precision for the motion detection is evaluated in some cases.

Heretofore, in a test mode in which such evaluation is made, a black area is provided in a part of an image, a motion in the image is judged from a change in image between the black area and its circumference, and the resulting judgment result is compared with a result of detecting the motion. Thus, the precision for the motion detection is evaluated.

Since the black signal is inserted into the picture by utilizing the method described above in the liquid crystal display device 1 according to the embodiment of the invention, the motion detection precision-evaluating circuit 24 can evaluate the precision for the motion detection by using the inserted black signal instead of specially providing the black area in a part of the image.

In addition, when the black signal is inserted into the picture, a difference between the picture having the black signal inserted thereinto and each of the pictures before and behind the picture having the black signal inserted thereinto becomes large. Hence, the liquid crystal display device having the overdrive function becomes easy to show the overdrive function.

However, it becomes the side effects in the above-mentioned test mode that the overdrive is too effective, and the precision of the motion detection may not be sufficiently evaluated.

In the light of this situation, in the liquid crystal display device 1 according to the embodiment of the invention, the provision of the ODC off circuit 22 makes it possible to stop the overdrive function.

### [Switching of Black Signal Insertion Mode]

As has already been described, in the liquid crystal display device 1 according to the embodiment of the invention, the insertion of the black signal as the interpolation signal into each of the interlace non-scanning portions makes it possible to prevent “the moving image blur” from occurring.

However, when the black signal is inserted into each of the interlace non-scanning portions so that the black image apparently occupies 50% of the full picture, the brightness of the overall picture is reduced to half that of the conventional one.

In order to overcome this situation, the user can select whether or not such black signal-inserting processing should be executed.

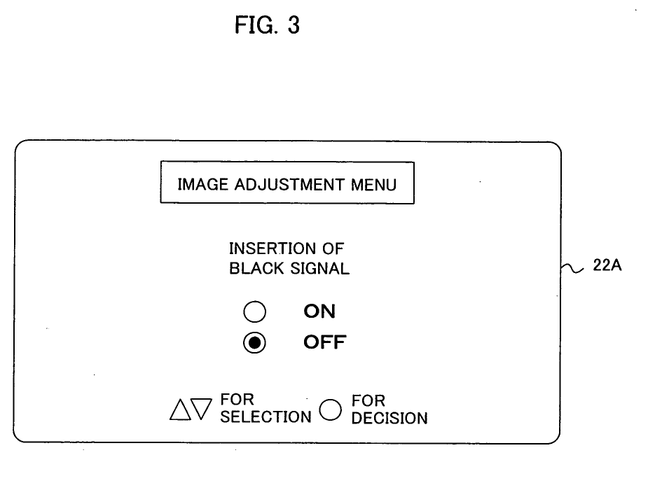

FIG. 3 is a display example of an OSD image menu with which the user can select whether or not such black signal-inserting processing should be executed.

Referring to FIG. 3, a graphical interface is displayed as an image selection menu 22A on the screen, so that the user can select whether the black signal-inserting processing is set to an “ON” mode or an “OFF” mode. The user can select one of the two choices by manipulating a remote control device or the like while looking at this graphical interface.

When the user sets the black signal-inserting processing to the OFF mode from the image selection menu 22A, no black signal-inserting processing is executed. In this case, the interpolation signal is generated in accordance with portions of the video signal corresponding to the upper and lower side scanning lines with respect to the scanning line concerned for the video signal instead of inserting the black signal as the interpolation signal. Thus, the resulting interpolation signals are composed to generate one frame.

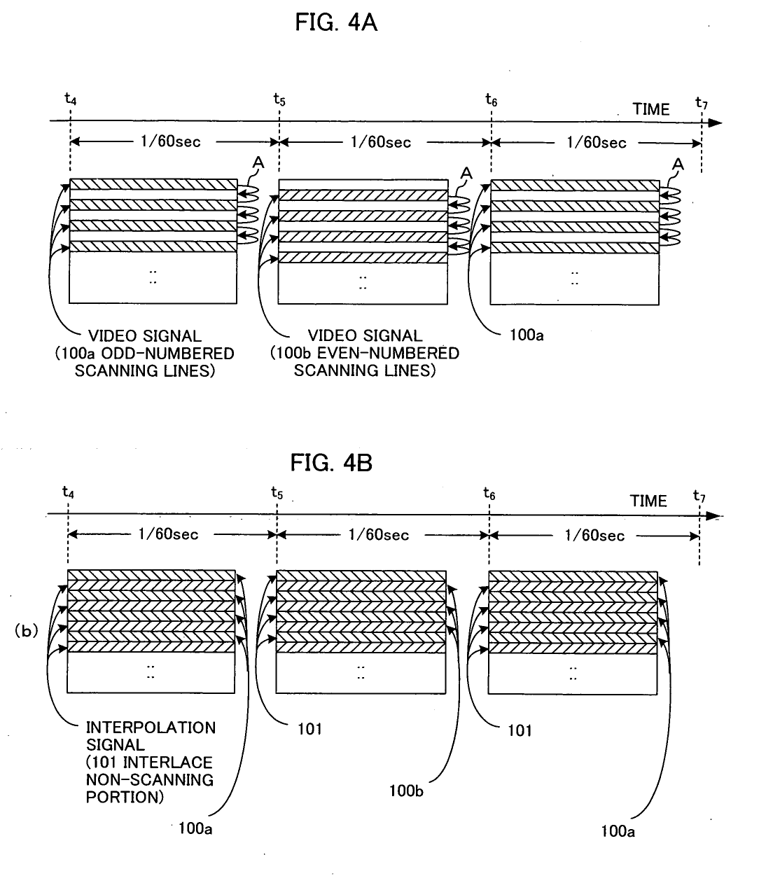

FIGS. 4A and 4B are respectively schematic diagrams showing an interpolation method in the OFF mode phase of the black signal-inserting processing.

When the video signal complying with the interlace system as shown in FIG. 4A is received, the interpolation signal is generated in accordance with the portions of the video signal corresponding to the upper and lower side scanning lines with respect to scanning line concerned for the video signal thus received (represented by reference symbol A in FIG. 4A). For the video signal received at t₄ or t₆, the interpolation signals for the even-numbered scanning lines 101 are generated because of execution of the interlace scanning for the odd-numbered scanning lines 100a. On the other hand, for the video signal received at t₅, the interpolation signals for the odd-numbered scanning lines 101 are generated because of execution of the interlace scanning for the even-numbered scanning lines 100b. Also, as shown in FIG. 4B, the interpolation signals are inserted into the corresponding interlace non-scanning portions 101, respectively, which results in that the video signal complying with the progressive system is obtained.

### [Scaling Processing]

The size of the image corresponding to the received video signal, and the image size of the LCD panel 23 do not necessarily agree with each other. For this reason, when both the sizes are different from each other, the scaling circuit 20 must execute the scaling processing.

However, in the case where the LCD panel 23, for example, is one having the number of pixels of 1,920×1,080 and complying with the full HD standard, when the received video signal complies with 1,080i, the image corresponding to the received video signal can be displayed without executing the scaling processing. In spite of this situation, if the scaling processing is executed, image resampling is performed for the image for which the black signal is inserted as the interpolation signal into each of the interlace non-scanning portions, and so forth. Thus, the original state cannot be maintained, so that the image in the interlace non-scanning portions into each of which the black signal is inserted becomes gray, and so forth. As a result, it becomes impossible to show the essential effects of the insertion of the black signal.

Then, when it is judged in accordance with the detection result obtained from the image detecting circuit 12 that the size of the image corresponding to the received video signal is identical to that of the LCD panel 23, the scaling processing is inhibited from being executed in the scaling circuit 20, which results in that it becomes possible to fully show the effect of the insertion of the black signal.

### EFFECTS OF EMBODIMENT

According to the liquid crystal display device according to the embodiment of the invention, the so-called “moving image blur” can be prevented from occurring because the insertion of the black signal into each of the corresponding interlace non-scanning portions in the phase of the IP conversion results in that even when any of the areas on the screen is viewed, the black image is apparently usually inserted into the picture at the rate of 50%.

In addition, the desired effect can be obtained in correspondence to the image because the user can switch whether or not the black signal should be inserted into each of the corresponding interlace non-scanning portions.

In addition, the insertion of the black signal in the phase of the IP conversion makes it possible to evaluate the motion detection.

Also, it is possible to prevent the effect of the insertion of the black signal from being reduced due to the insertion of the black signal in the phase of the IP conversion because the scaling circuit executes the scaling processing in accordance with the size of the image corresponding to the received video signal.

It should be noted that the present invention is not limited to the embodiment described above, and the various combinations and changes may be made without departing from or changing the technical idea of the present invention.

What is claimed is:

1. A liquid crystal display device, comprising:
a receiving portion for receiving a video signal;
a motion detecting portion for detecting whether an image corresponding to the video signal is a still image or a moving images; and
an interpolation signal-inserting portion for, when the motion detecting portion detects that the image corresponding to the video signal is the moving image complying with an interlace system, inserting a black signal into each of interlace non-scanning portions for the video signal.

2. A liquid crystal display device according to claim 1, wherein the interpolation signal-inserting portion determines, whether the black signal or a signal generated in accordance with signal portions corresponding to upper and lower side scanning lines with respect to a scanning line concerned for the video signal is used as the interpolation signal, in accordance with selection by a user.

3. A liquid crystal display device according to claim 1, wherein the motion detecting portion detects whether an image corresponding to the video signal is the still image or the moving image by obtaining a difference between two continuous frames.

4. A liquid crystal display device according to claim 1, wherein when the motion detecting portion judges that an image corresponding to the video signal is the still image, the interpolation signal-inserting portion inserts an interlace scanning line of an precedent field into the interlace non-scanning portion for the video signal.

5. A liquid crystal display device according to claim 2, wherein the interpolation signal-inserting portion includes a black signal-inserting circuit for generating the black signal, the black signal-inserting portion being selected in accordance with a user selection of an image adjustment menu displayed on a liquid crystal display panel.

6. A liquid crystal display device according to claim 4, wherein the interpolation signal-inserting portion includes a one field delaying circuit for storing a video signal of the precedent field.

7. A liquid crystal display device according to claim 2, wherein the interpolation signal-inserting portion includes an intrafield processing circuit for generating the interpolation signal.

8. A liquid crystal display device, comprising:
a receiving portion for receiving a video signal;
a motion detecting portion for detecting whether an image corresponding to the video signal is a still image or a moving images;
an interpolation signal-inserting portion for, when the motion detecting portion detects that the image corresponding to the video signal is the moving image complying with an interlace system, inserting a black signal into each of interlace non-scanning portions for the video signal; and
a size converting portion for converting a size of the image corresponding to the video signal only when a display size of the image corresponding to the video signal and a display size of a liquid crystal panel for displaying thereon an image are different from each other.

9. A liquid crystal display device according to claim 8, wherein the interpolation signal-inserting portion determines, whether the black signal or a signal generated in accordance with signal portions corresponding to upper and lower side scanning lines with respect to a scanning line concerned for the video signal is used as the interpolation signal, in accordance with selection by a user.

10. A liquid crystal display device according to claim 8, wherein the motion detecting portion detects whether an image corresponding to the video signal is the still image or the moving image by obtaining a difference between two continuous frames.

11. A liquid crystal display device according to claim 8, wherein when the motion detecting portion judges that an image corresponding to the video signal is the still image, the interpolation signal-inserting portion inserts an interlace scanning line of a precedent field into the interlace non-scanning portion for the video signal.

12. A liquid crystal display device according to claim 9, wherein the interpolation signal-inserting portion includes a black signal-inserting circuit for generating the black signal, the black signal-inserting portion being selected in accordance with a user selection of an image adjustment menu displayed on a liquid crystal display panel.

13. A liquid crystal display device according to claim 11, wherein the interpolation signal-inserting portion includes a one field delaying circuit for storing a video signal of the precedent field.

14. A liquid crystal display device according to claim 9, wherein the interpolation signal-inserting portion includes an intrafield processing circuit for generating the interpolation signal.

15. A liquid crystal display device, comprising:
a receiving portion for receiving a video signal;
a motion detecting portion for detecting whether an image corresponding to the video signal is a still image or a moving images;
an interpolation signal-inserting portion for, when the motion detecting portion detects that the image corresponding to the video signal is a moving image complying with an interlace system, inserting a black signal into each of interlace non-scanning portions for the video signal; and
a motion detection-evaluating portion for evaluating detection precision in the motion detecting portion by using the block signal inserted as an interpolation signal by the interpolation signal-inserting portion.

16. A liquid crystal display device according to claim 15, wherein when evaluating the detection precision in the motion detecting portion, the motion detection-evaluating portion stops an overdrive function.

17. A liquid crystal display device according to claim 15, wherein the motion detecting portion detects whether an image corresponding to the video signal is the still image or the moving image by obtaining a difference between two continuous frames.

18. A liquid crystal display device according to claim 15, wherein the motion detecting portion detects whether an image corresponding to the video signal is the still image or the moving image by obtaining a difference between two continuous frames.

19. A liquid crystal display device according to claim 15, wherein the interpolation signal-inserting portion includes a black signal-inserting circuit for generating the black signal, the black signal-inserting portion being selected in accordance with a user selection of an image adjustment menu displayed on a liquid crystal display panel.

20. A liquid crystal display device according to claim 15, wherein the interpolation signal-inserting portion includes an intrafield processing circuit for generating the interpolation signal.
